(19) United States
(12) Patent Application Publication
(10) Pub. No.: US 2026/0322293 A1
(43) Pub. Date: Oct. 15, 2026

(54) MONITORING STATE-OF-HEALTH OF A MOTOR DRIVE SYSTEM

(71) Applicant: Qorvo US, Inc., Greensboro, NC (US)

(72) Inventors: Shao Zhang, Allen, TX (US); Chao Dong, Shanghai (CN); Jonathan De Luna-Rodriguez, The Colony, TX (US)

(21) Appl. No.: 19/539,223

(22) Filed: Feb. 13, 2026

Related U.S. Application Data
(60) Provisional application No. 63/760,715, filed on Feb. 20, 2025.

(51) Int. Cl. H02P 6/182; H02P 6/14; H02P 29/024

(52) U.S. Cl. CPC H02P 6/182; H02P 6/14; H02P 29/0241

(57) ABSTRACT

Monitoring a state-of-health (SOH) in a motor drive system is provided. Herein, the motor drive system includes a three-phase motor, a three-phase inverter, and a motor control circuit. The motor control circuit is configured to extrapolate SOHs of the three-phase motor and the three-phase inverter by analyzing characteristics of phase currents induced in the three-phase motor. By analyzing the characteristics of the phase currents in real time, it is possible to determine the SOHs without requiring extra hardware (e.g., sensors, high-precision analog-to-digital converters, etc.), thus helping to reduce size, weight, and cost of the motor drive system.

### RELATED APPLICATIONS

This application claims the benefit of U.S. provisional patent application Ser. No. 63/760,715, filed on Feb. 20, 2025, the disclosure of which is hereby incorporated herein by reference in its entirety.

### FIELD OF THE DISCLOSURE

The present disclosure is related to monitoring a state-of-health (SOH) of a motor drive system, such as a three-phase brushless direct current motor (BLDCM) drive system.

### BACKGROUND

Brushless direct current motors (BLDCMs) have been widely used in household appliances, computer data centers, automobile industries, aerial and aerospace industries, and so on. As such, it becomes increasingly critical to monitor a state-of-health (SOH) of the BLDCMs, especially in a motor drive system that drives such mission critical applications as automobile, aerial, and aerospace industries.

Conventionally, various types of sensors are embedded in the motor drive system to detect such abnormal conditions as motor vibration, overheating, and so on. However, any addition of such sensors can lead to an increase in size, weight, and cost of the motor drive system. Moreover, regardless of whether the abnormal conditions are detected based on existing or extra hardware, time domain signal processing methods typically require pre-storing many predefined thresholds for motor current, voltage, and sensor data. As the predefined thresholds can change from one setup to another in the motor drive system, it is difficult to scale the motor drive system for mass production. As such, it is desirable to monitor the SOH of the motor drive system by analyzing BLDCM current characteristics without adding any extra sensors.

### SUMMARY

Embodiments of the disclosure relate to monitoring a state-of-health (SOH) of a motor drive system. Herein, the motor drive system includes a three-phase motor, a three-phase inverter, and a motor control circuit. The motor control circuit is configured to extrapolate SOHs of the three-phase motor and the three-phase inverter by analyzing characteristics of phase currents induced in the three-phase motor. By analyzing the characteristics of the phase currents in real time, it is possible to determine the SOHs without requiring extra hardware (e.g., sensor, high-precision analog-to-digital converter, etc.), thus helping to reduce size, weight, and cost of the motor drive system.

In one aspect, a motor drive system is provided. The motor drive system includes a three-phase motor. The three-phase motor is powered by three phase voltages to thereby induce three phase currents. The motor drive system also includes a three-phase inverter. The three-phase inverter is coupled between a positive voltage rail and a negative voltage rail. The three-phase inverter is biased by three gate drive voltages to thereby provide the three phase voltages to the three-phase motor. The motor drive system also includes a motor control circuit. The motor control circuit is configured to generate the three gate drive voltages to thereby bias the three-phase inverter. The motor control circuit is also configured to receive feedback of the three phase currents and feedback of the three phase voltages. The motor control circuit is also configured to determine an SOH of the three-phase motor based on the feedback of the three phase currents. The motor control circuit is also configured to determine an SOH of the three-phase inverter based on the feedback of the three phase currents and the feedback of the three phase voltages. The motor control circuit is also configured to determine an overall state-of-health of the motor drive system based on the determined state-of-health of the three-phase motor and the determined state-of-health of the three-phase inverter.

In another aspect, a method for monitoring the SOH of a motor drive system is provided. The method includes powering a three-phase motor coupled between a positive voltage rail and a negative voltage rail with three phase voltages to thereby induce three phase currents. The method also includes biasing a three-phase inverter by three gate drive voltages to thereby provide the three phase voltages to the three-phase motor. The method also includes receiving feedback of the three phase currents and feedback of the three phase voltages. The method also includes determining an SOH of the three-phase motor based on the feedback of the three phase currents. The method also includes determining an SOH of the three-phase inverter based on the feedback of the three phase currents and the feedback of the three phase voltages. The method also includes determining an overall state-of-health of the motor drive system based on the determined state-of-health of the three-phase motor and the determined state-of-health of the three-phase inverter.

In another aspect, electric equipment is provided. The electric equipment includes a motor drive system. The motor drive system includes a three-phase motor. The three-phase motor is powered by three phase voltages to thereby induce three phase currents. The motor drive system also includes a three-phase inverter. The three-phase inverter is coupled between a positive voltage rail and a negative voltage rail. The three-phase inverter is biased by three gate drive voltages to thereby provide the three phase voltages to the three-phase motor. The motor drive system also includes a motor control circuit. The motor control circuit is configured to generate the three gate drive voltages to thereby bias the three-phase inverter. The motor control circuit is also configured to receive feedback of the three phase currents and feedback of the three phase voltages. The motor control circuit is also configured to determine an SOH of the three-phase motor based on the feedback of the three phase currents. The motor control circuit is also configured to determine an SOH of the three-phase inverter based on the feedback of the three phase currents and the feedback of the three phase voltages. The motor control circuit is also configured to determine an overall state-of-health of the motor drive system based on the determined state-of-health of the three-phase motor and the determined state-of-health of the three-phase inverter.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic diagram of an exemplary motor drive system wherein a motor control circuit can be configured according to embodiments of the present disclosure to dynamically monitor a state-of-health (SOH) of a three-phase motor and a three-phase inverter;

FIG. 2 is a schematic diagram of an exemplary digital processing circuit provided in the motor control circuit in FIG. 1 and configured to determine the SOH of the three-phase motor;

FIG. 3 is a graphic diagram providing an exemplary visual illustration as to how the digital processing circuit of FIG. 2 can detect vibration and demagnetizing behavior as part of the SOH of the three-phase motor;

FIG. 4 is a schematic diagram of an exemplary inverter fault detector provided in the motor control circuit in FIG. 1 to detect the SOH of the three-phase inverter based on a pair of threshold voltages;

FIG. 5 is a schematic diagram providing an exemplary illustration as to how the digital processing circuit of FIG. 2 can determine the pair of threshold voltages used for determining the SOH of the three-phase inverter; and

FIG. 6 is a flowchart of an exemplary process for monitoring the SOH of the motor drive system of FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to monitoring a state-of-health (SOH) of a motor drive system. Herein, the motor drive system includes a three-phase motor, a three-phase inverter, and a motor control circuit. The motor control circuit is configured to extrapolate SOHs of the three-phase motor and the three-phase inverter by analyzing characteristics of phase currents induced in the three-phase motor. By analyzing the characteristics of the phase currents in real time, it is possible to determine the SOHs without requiring extra hardware (e.g., sensors, high-precision analog-to-digital converters, etc.), thus helping to reduce size, weight, and cost of the motor drive system.

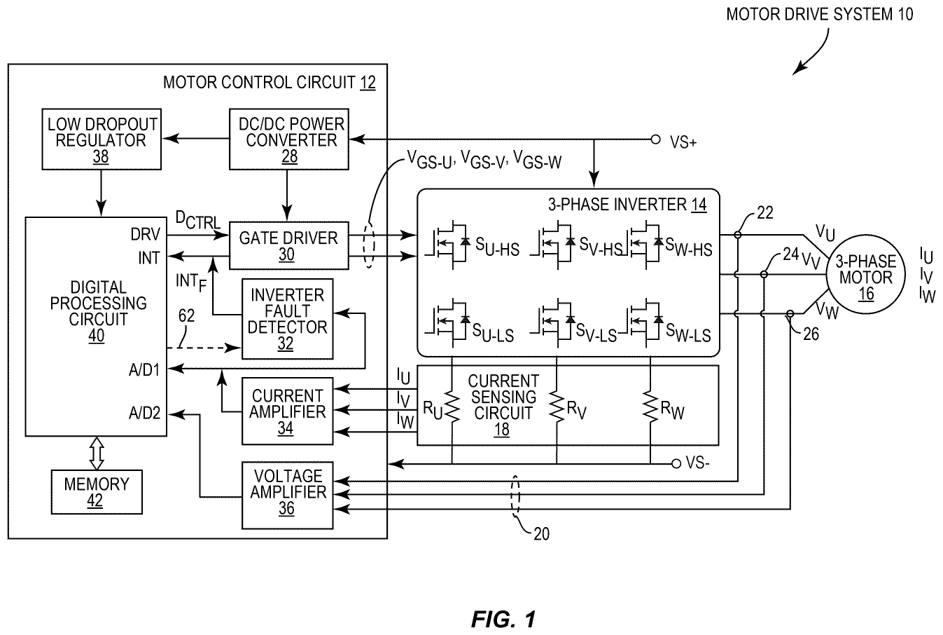

FIG. 1 is a schematic diagram of an exemplary motor drive system 10 wherein a motor control circuit 12 can be configured according to embodiments of the present disclosure to dynamically monitor the SOH of the motor drive system. In an embodiment, the motor drive system 10 includes the motor control circuit 12, a three-phase (3-phase) inverter 14, and a three-phase (3-phase) motor 16 (e.g., BLDCM). In context of the present disclosure, the SOH of the motor drive system 10 is collectively determined by the SOH of the three-phase inverter 14 and the SOH of the three-phase motor 16. More specifically, the SOH of the three-phase inverter 14 indicates whether there exists abnormal voltage drops in the three-phase inverter 14, and the SOH of the three-phase motor 16 indicates whether there exists motor vibration, demagnetizing, and motor winding unbalance/de-insulation issues in the three-phase motor 16.

The three-phase motor 16 is powered by three phase voltages V_{U}, V_{V}, V_{W} supplied by the three-phase inverter 14. The phase voltages V_{U}, V_{V}, V_{W} cause internal windings in the three-phase motor 16 to induce three phase currents I_{U}, I_{V}, I_{W} and, thereby, create rotating magnetic fields. The three-phase inverter 14 includes three high-side switches S_{U-HS}, S_{V-HS}, S_{W-HS} and three low-side switches S_{U-LS}, S_{V-LS}, S_{W_LS}. The high-side switches S_{U-HS}, S_{V-HS}, S_{W-HS} are each coupled to a positive voltage rail VS+, whereas the low-side switches S_{U-LS}, S_{V-LS}, S_{W_LS} are each coupled to a negative voltage rail VS− via a respective one of three current sensing resistors R_{U}, R_{V}, R_{W}. In an embodiment, each of the high-side switches S_{U-HS}, S_{V-HS}, S_{W-HS} and the low-side switches S_{U-LS}, S_{V-LS}, S_{W_LS} can be power transistors (e.g., metal oxide semiconductor field-effect transistors or insulated gate bipolar transistors). As such, the current sensing resistors R_{U}, R_{V}, R_{W} can collectively form a current sensing circuit 18 to sense the phase currents I_{U}, I_{V}, I_{W} in the three-phase motor 16. Herein, the current sensing circuit 18 is configured to provide the sensed phase currents I_{U}, I_{V}, I_{W} to the motor control circuit 12.

The motor drive system 10 also includes a voltage feedback loop 20, which is coupled to a first motor winding terminal 22, a second motor winding terminal 24, and a third motor winding terminal 26. By way of example, the first motor winding terminal 22, the second motor winding terminal 24, and the third motor winding terminal 26 are configured to provide the three phase voltages V_{U}, V_{V}, V_{W} from the three-phase inverter 14 to the three-phase motor 16, respectively. Accordingly, the voltage feedback loop 20 is configured to provide feedback of the phase voltages V_{U}, V_{V}, V_{W}, as supplied to the three-phase motor 16 by the three-phase inverter 14, to the motor control circuit 12.

As described in detail below, the motor control circuit 12 can extrapolate the SOH of the motor drive system 10 based on characteristics of the phase voltages V_{U}, V_{V}, V_{W} and/or the phase currents I_{U}, I_{V}, I_{W}. As such, it is possible to determine the SOH of the motor drive system 10 without requiring extra hardware, thus helping to reduce size, weight, and cost of the motor drive system 10.

The motor control circuit 12 includes such analog circuitries as a direct current-to-direct current (DC/DC) power converter 28, a gate driver 30, an inverter fault detector 32, a current amplifier 34, a voltage amplifier 36, and a low dropout regulator 38. In some embodiments, the inverter fault detector 32, the current amplifier 34, and the voltage amplifier 36 may receive power from the DC/DC power converter 28. Alternatively, the inverter fault detector 32, the current amplifier 34, and the voltage amplifier 36 may also receive power from the low dropout regulator 38. The three-phase inverter 14 may receive power from an external voltage source (not shown) that is coupled between the positive voltage rail VS+ and the negative voltage rail VS−.

The motor control circuit 12 also includes such digital circuitries as a digital processing circuit 40 and a memory 42. The digital processing circuit 40 is powered by the low dropout regulator 38. The memory 42 is configured with firmware that is executed by the digital processing circuit 40 to generate a drive control signal D_{CTRL} at a drive control output DRV. In operation, the drive control signal D_{CTRL} directs the gate driver 30 to generate gate drive voltages V_{GS-U}, V_{GS-V}, V_{GS-W} for the three-phase inverter 14. Specifically, the gate drive voltage V_{GS-U} can bias the high-side switch S_{U-HS} and the low-side switch S_{U-LS} to thereby provide the phase voltage V_{U} to the three-phase motor 16, the gate drive voltage V_{GS-V} can bias the high-side switch S_{V-HS} and the low-side switch S_{V-LS} to thereby provide the phase voltage V_{V} to the three-phase motor 16, and the gate drive voltage V_{GS-W} can bias the high-side switch S_{W-HS} and the low-side switch S_{W-LS} to thereby provide the phase voltage V_{W} to the three-phase motor 16.

In an embodiment, the motor control circuit 12 is an integrated circuit that integrates the analog circuitries with the digital circuitries. During operation, the DC/DC power converter 28 receives power from the external voltage source coupled between the positive voltage rail VS+ and the negative voltage rail VS−. The DC/DC power converter 28 then outputs converted power at voltage levels required by the gate driver 30 and the low dropout regulator 38. In turn, the low dropout regulator 38 provides regulated power to the digital processing circuit 40 and the memory 42.

The current amplifier 34 receives the sensed phase currents I_{U}, I_{V}, I_{W} from the current sensing circuit 18. The current amplifier 34 amplifies the sensed phase currents I_{U}, I_{V}, I_{W} and then provides the amplified phase currents I_{U}, I_{V}, I_{W} to a first analog-to-digital converter A/D1 in the digital processing circuit 40. The voltage amplifier 36 receives the feedback of the phase voltages V_{U}, V_{V}, V_{W} via the voltage feedback loop 20. The voltage amplifier 36 amplifies the feedback of the phase voltages V_{U}, V_{V}, V_{W} and then provides the amplified phase voltages V_{U}, V_{V}, V_{W} to a second analog-to-digital converter A/D2 in the digital processing circuit 40. The first analog-to-digital converter A/D1 and the second analog-to-digital converter A/D2 are configured to convert the amplified phase currents I_{U}, I_{V}, I_{W} and the amplified phase voltages V_{U}, V_{V}, V_{W} into digitized phase voltages V_{U}, V_{V}, V_{W} and digitized phase currents I_{U}, I_{V}, I_{W}. Accordingly, the digital processing circuit 40 can determine the SOH of the motor drive system 10 in a digital domain based on the digitized phase voltages V_{U}, V_{V}, V_{W} and the digitized phase currents I_{U}, I_{V}, I_{W}.

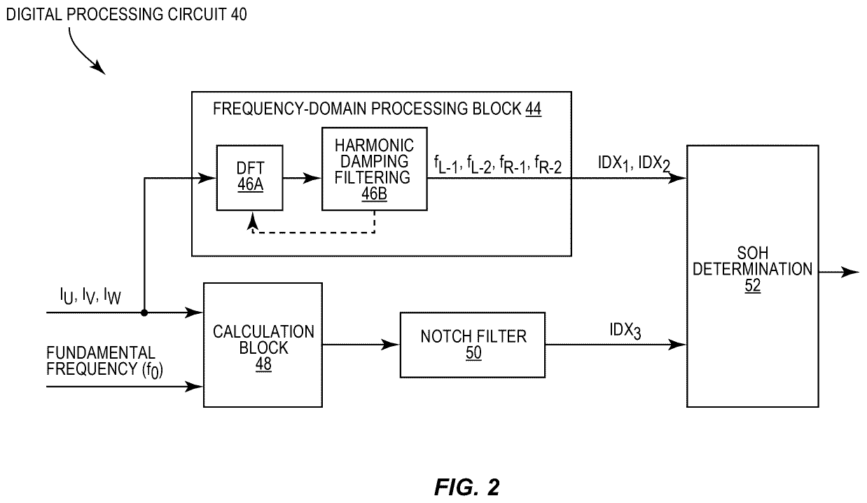

FIG. 2 is a schematic diagram providing an exemplary illustration of the digital processing circuit 40 in FIG. 1, which is configured according to embodiments of the present disclosure to determine the SOH of the three-phase motor 16. Common elements between FIGS. 1 and 2 are shown therein with common element numbers and will not be re-described herein.

The digital processing circuit 40 receives the digitized phase currents I_{U}, I_{V}, I_{W} via the first analog-to-digital converter A/D1. The digital processing circuit 40 is also configured to determine a fundamental frequency f₀ of the three-phase motor 16, which corresponds to a motor electric speed of the three-phase motor 16. In one embodiment, the digital processing circuit 40 may derive the fundamental frequency f₀ from a sinusoid frequency of any of the digitized phase currents I_{U}, I_{V}, I_{W}. Alternatively, the digital processing circuit 40 may receive an indication of the motor electric speed from a speed sensor or a speed estimator, should such sensor be readily available.

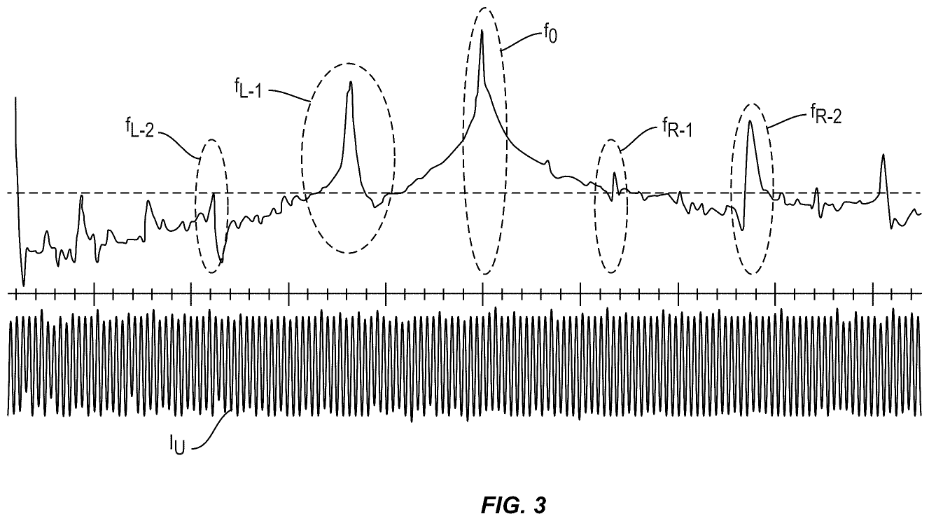

The digital processing circuit 40 also includes a frequency-domain processing block 44. In an embodiment, the frequency-domain processing block 44 can be configured to perform one or more iterations of Discrete Fourier Transform (DFT) 46A and harmonic damping filtering 46B on any of the digitized phase currents I_{U}, I_{V}, I_{W} to thereby calculate a first left harmonic f_{L-1}, a second left harmonic f_{L-2}, a first right harmonic f_{R-1}, and a second right harmonic f_{R-2}, each of which is a function of the fundamental frequency f₀. FIG. 3 is a graphic diagram providing an exemplary visual illustration of a relationship between the first left harmonic f_{L-1}, the second left harmonic f_{L-2}, the first right harmonic f_{R-1}, the second right harmonic f_{R-2}, and the fundamental frequency f₀. As shown in FIG. 3, each of the first left harmonic f_{L-1}, the second left harmonic f_{L-2}, the first right harmonic f_{R-1}, and the second right harmonic f_{R-2} is relative to the fundamental frequency f₀. As shown herein, the fundamental frequency f₀ may be derived from the phase current I_{U}.

With reference back to FIG. 2, the digital processing circuit 40 can be configured to determine the first left harmonic f_{L-1}, the second left harmonic f_{L-2}, the first right harmonic f_{R-1}, and the second right harmonic f_{R-2} in accordance with equations (Eq. 1.1-1.4) below.

f_{L-1}=(1−1/pp)*f₀ (Eq. 1.1)

f_{L-2}=(1−2/pp)*f₀ (Eq. 1.2)

f_{R-1}=(1+2/pp)*f₀ (Eq. 1.3)

f_{R-2}=(1+4/pp)*f₀ (Eq. 1.4)

In the equations (Eq. 1.1-1.4), pp represents a motor pole pair, which refers to a pair of magnetic poles that collectively produce one magnetic field cycle around the three-phase motor 16. Herein, the magnitudes of the first left harmonic f_{L-1}, the second left harmonic f_{L-2}, the first right harmonic f_{R-1}, and the second right harmonic f_{R-2} are scaled to magnitude of the fundamental frequency f₀ for general application purposes. By analyzing a signature of the first left harmonic f_{L-1}, the second left harmonic f_{L-2}, the first right harmonic f_{R-1}, and the second right harmonic f_{R-2}, the digital processing circuit 40 can determine a motor vibration index (IDX₁) and a motor demagnetizing index (IDX₂). In an embodiment, the digital processing circuit 40 can determine the motor vibration index (IDX₁) by multiple readings/measurements of the first left harmonic f_{L-1}. The digital processing circuit 40 can also determine the motor demagnetizing index (IDX₂) by analyzing the second left harmonic f_{L-2}, the first right harmonic f_{R-1}, and the second right harmonic f_{R-2}.

The digital processing circuit 40 can further determine a motor phase imbalance index (IDX₃) based on the digitized phase currents I_{U}, I_{V}, I_{W}. Specifically, the digital processing circuit 40 includes a calculation block 48 that calculates a balance index of the digitized phase currents I_{U}, I_{V}, I_{W} in accordance with equation (Eq. 2) below.

Balance Index=I_{U}²+I_{V}²+I_{W}² (eq. 2)

In the balance index as calculated in the equation (Eq. 2), the sinusoidal phase currents I_{U}, I_{V}, I_{W} are converted into a DC current with harmonics as the 3-order and the 6-order of the fundamental frequency f₀. The digital processing circuit 40 also includes a notch filter 50 configured to apply a two-cascade notch filtering to thereby remove the 3-order and the 6-order harmonics. As a result, the phase imbalance index (IDX₃) will only represent motor phase imbalance characteristics.

Subsequently, a SOH determination block 52 in the digital processing circuit 40 can process the motor vibration index (IDX₁), the motor demagnetizing index (IDX₂), and the motor phase imbalance index (IDX₃) to thereby determine the SOH of the three-phase motor 16 as part of the overall SOH of the motor drive system 10. The resulting SOH of the three-phase motor 16 may be stored in the memory 42 or communicated to an external circuit (not shown), such as an SOH monitoring/alerting circuit.

With reference back to FIG. 1, the inverter fault detector 32 has an output coupled to an interrupt input INT of the digital processing circuit 40, which also receives feedback from the gate driver 30. The inverter fault detector 32 is configured herein to detect a fault condition in the three-phase inverter 14. More specifically, the inverter fault detector 32 can detect an abnormal voltage drop in any of the high-side switches S_{U-HS}, S_{V-HS}, S_{W-HS} and the low-side switches S_{U-LS}, S_{V-LS}, S_{W-LS}. In response to detecting such a fault condition in the three-phase inverter 14, the inverter fault detector 32 provides an interruption INT_{F} to the interrupt input INT of the digital processing circuit 40. Accordingly, the digital processing circuit 40 can determine the SOH of the three-phase inverter 14 as part of the overall SOH of the motor drive system 10. The resulting SOH of the three-phase inverter 14 may be stored in the memory 42 or communicated to the external circuit.

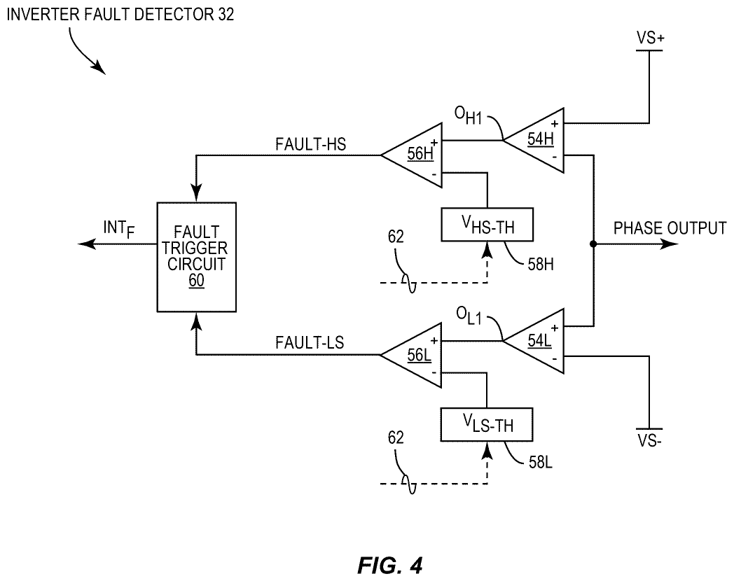

FIG. 4 is a schematic diagram providing an exemplary illustration of the inverter fault detector 32 configured according to an embodiment of the present disclosure. Common elements between FIGS. 1 and 4 are shown therein with common element numbers and will not be re-described herein.

In an embodiment, the inverter fault detector 32 includes a pair of high-side comparators 54H (a.k.a. “first high-side comparator”), 56H (a.k.a. “second high-side comparator”), a pair of low-side comparators 54L (a.k.a. “first low-side comparator”), 56L (a.k.a. “second low-side comparator”), a high-side register 58H, a low-side register 58L, and a fault trigger circuit 60. The high-side register 58H is configured to store a high-side threshold voltage V_{HS-TH} and the low-side register 58L is configured to store a low-side threshold voltage V_{LS-TH}.

The first high-side comparator 54H has a respective positive input (denoted as “+”) coupled to the positive voltage rail VS+ and a respective output O_{H1} coupled to a respective positive input (denoted as “+”) of the second high-comparator 56H. The first low-side comparator 54L has a respective negative input (denoted as “−”) coupled to the negative voltage rail VS− and a respective output O_{L1} coupled to a respective positive input (denoted as “+”) of the second low-comparator 56L. A respective negative input (denoted as “−”) of the first high-side comparator 54H is coupled to a respective positive input (denoted as “+”) of the first low-side comparator 54L. As an example, the negative input of the first high-side comparator 54H and the positive input of the first low-side comparator 54L can collectively produce a phase output.

The second high-side comparator 56H is coupled to the positive voltage rail VS+ via the first high-side comparator 54H, and the second low-side comparator 56L is coupled to the negative voltage rail VS− via the first low-side comparator 54L. The second high-side comparator 56H is configured to generate a high-side fault indication FAULT-HS when a voltage difference between the positive voltage rail VS+ and each of the phase voltages V_{U}, V_{V}, V_{W} is larger than the high-side threshold voltage V_{HS-TH}. The second low-side comparator 56L is configured to generate a low-side fault indication FAULT-LS when a voltage difference between each of the phase voltages V_{U}, V_{V}, V_{W} and the negative voltage rail VS− is larger than the low-side threshold voltage V_{LS-TH}. The fault trigger circuit 60 is configured to provide the interruption INT_{F} to the interrupt input INT of the digital processing circuit 40 in the presence of any of the high-side fault indication FAULT-HS and the low-side fault indication FAULT-LS. In an embodiment, the interruption INT_{F} can disable the gate driver 30 in the motor control circuit 12 to thereby protect the three-phase inverter 14 immediately.

With reference back to FIG. 1, the digital processing circuit 40 can be configured to initialize and update the high-side threshold voltage V_{HS-TH} and the low-side threshold voltage V_{LS-TH} in the high-side register 58H and the low-side register 58L, respectively, via a register write via a signal line 62. In an embodiment, the digital processing circuit 40 can determine the high-side threshold voltage V_{HS-TH} and the low-side threshold voltage V_{LS-TH} based on a threshold voltage lookup table (LUT) that correlates the high-side threshold voltage V_{HS-TH} and the low-side threshold voltage V_{LS-TH} with a root-mean-square (RMS) of the digitized phase currents I_{V}, I_{V}, I_{W} and the gate drive voltages V_{GS-U}, V_{GS-V}, V_{GS-W}.

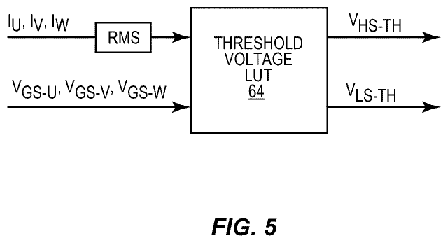

FIG. 5 is a schematic diagram providing an exemplary visual illustration of the process whereby the digital processing circuit 40 can determine the high-side threshold voltage V_{HS-TH} and the low-side threshold voltage V_{LS-TH}. Herein, the digital processing circuit 40 determines the high-side threshold voltage V_{HS-TH} and the low-side threshold voltage V_{LS-TH} from a threshold voltage LUT 64, which can be preconfigured to correlate the high-side threshold voltage V_{HS-TH} and the low-side threshold voltage V_{LS-TH} with a root-mean-square (RMS) of the digitized phase currents I_{U}, I_{V}, I_{W} and the gate drive voltages V_{GS-U}, V_{GS-V}, VGS-W.

The motor drive system 10 of FIG. 1 may be employed in various electric equipment, including but not limited to home appliances, water and medical pumps, ceiling/floor fans, electric bikes, drones, and electric vehicles.

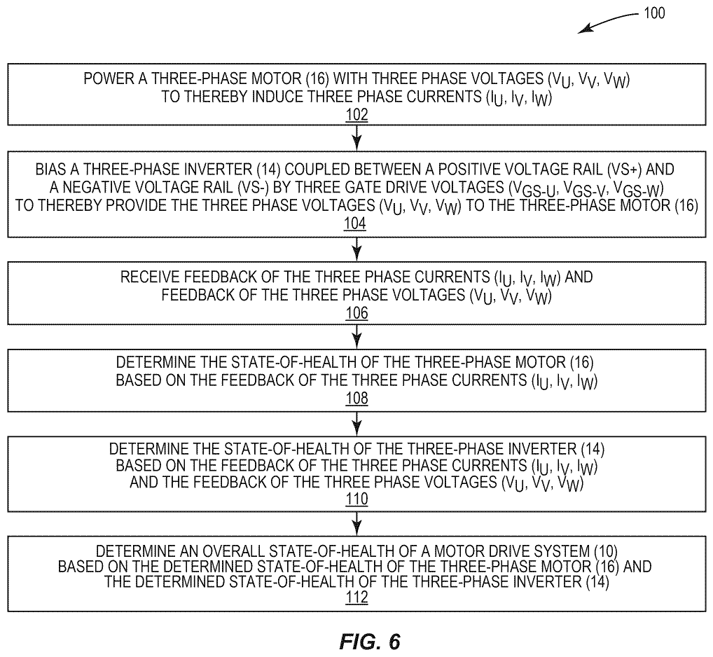

In an embodiment, it is possible to monitor the SOH of the motor drive system 10 in accordance with a process. In this regard, FIG. 6 is a flowchart of an exemplary process 100 for monitoring the SOH of the motor drive system 10 of FIG. 1.

Herein, the process 100 includes powering the three-phase motor 16 with the phase voltages V_{U}, V_{V}, V_{W} to thereby induce the phase currents I_{U}, I_{V}, I_{W} (step 102). The process 100 also includes biasing the three-phase inverter 14 coupled between the positive voltage rail VS+ and the negative voltage rail VS− by the gate drive voltages V_{GS-U}, V_{GS-V}, V_{GS-W} to thereby provide the phase voltages V_{U}, V_{V}, V_{W} to the three-phase motor 16 (step 104). The process 100 also includes receiving feedback of the phase currents I_{U}, I_{V}, I_{W} and feedback of the phase voltages V_{U}, V_{V}, V_{W} (step 106). The process 100 also includes determining the SOH of the three-phase motor 16 based on the feedback of the phase currents I_{U}, I_{V}, I_{W} (step 108). The process 100 also includes determining the SOH of the three-phase inverter 14 based on the feedback of the phase currents I_{U}, I_{V}, I_{W} and the feedback of the phase voltages V_{U}, V_{V}, V_{W} (step 110). The process 100 also includes determining the overall state-of-health of the motor drive system 10 based on the determined state-of-health of the three-phase motor 16 and the determined state-of-health of the three-phase inverter 14 (step 112).

Those skilled in the art will recognize improvements and modifications to the preferred embodiments of the present disclosure. All such improvements and modifications are considered within the scope of the concepts disclosed herein and the claims that follow.

What is claimed is:

1. A motor drive system comprising:
a three-phase motor powered by three phase voltages to thereby induce three phase currents;
a three-phase inverter coupled between a positive voltage rail and a negative voltage rail, the three-phase inverter is biased by three gate drive voltages to thereby provide the three phase voltages to the three-phase motor; and
a motor control circuit configured to:
generate the three gate drive voltages to thereby bias the three-phase inverter;
receive feedback of the three phase currents and feedback of the three phase voltages;
determine a state-of-health of the three-phase motor based on the feedback of the three phase currents;
determine a state-of-health of the three-phase inverter based on the feedback of the three phase currents and the feedback of the three phase voltages; and
determine an overall state-of-health of the motor drive system based on the determined state-of-health of the three-phase motor and the determined state-of-health of the three-phase inverter.

2. The motor drive system of claim 1, further comprising:
a current sensing circuit coupled to the three-phase inverter and configured to provide the feedback of the three phase currents to the motor control circuit; and
a voltage feedback loop coupled to the three-phase motor and configured to provide the feedback of the three phase voltages to the motor control circuit.

3. The motor drive system of claim 2, wherein the motor control circuit comprises:
a current amplifier circuit coupled to the current sensing circuit and configured to amplify the feedback of the three phase currents; and
a voltage amplifier circuit coupled to the voltage feedback loop and configured to amplify the feedback of the three phase voltages.

4. The motor drive system of claim 1, wherein the motor control circuit comprises a digital processing circuit configured to:
digitize the feedback of the three phase currents and the feedback of the three phase voltages;
determine the state-of-health of the three-phase motor based on the digitized feedback of the three phase currents; and
determine the state-of-health of the three-phase inverter based on the digitized feedback of the three phase currents and the digitized feedback of the three phase voltages.

5. The motor drive system of claim 4, wherein the digital processing circuit is further configured to:
determine a fundamental frequency of the three-phase motor;
perform one or more iterations of Discrete Fourier Transform (DFT) and harmonic damping filtering on the digitized feedback of the three phase currents to thereby calculate a first left harmonic, a second left harmonic, a first right harmonic, and a second right harmonic relative to the determined fundamental frequency;
calculate a motor vibration index based on the first left harmonic calculated through the one or more iterations; and
calculate a motor demagnetizing index based on the second left harmonic, the first right harmonic, and the second right harmonic calculated through the one or more iterations.

6. The motor drive system of claim 4, wherein the digital processing circuit is further configured to:
calculate a balance index of the digitized feedback of the three phase currents; and
apply notch filtering on the balance index to thereby determine a motor phase imbalance index.

7. The motor drive system of claim 4, wherein the motor control circuit further comprises an inverter fault detector configured to:
determine a fault condition in the three-phase inverter based on a high-side threshold voltage and a low-side threshold voltage;
provide an interruption to the digital processing circuit in response to detecting the fault condition; and
disable a gate driver that biases the three-phase inverter and the three gate drive voltages to thereby protect the three-phase inverter.

8. The motor drive system of claim 7, wherein the inverter fault detector comprises:
a pair of high-side comparators configured to generate a high-side fault indication when a voltage difference between the positive voltage rail and each of the three phase voltages is higher than the high-side threshold voltage;
a pair of low-side comparators configured to generate a low-side fault indication when a voltage drop between each of the three phase voltages and the negative voltage rail is higher than the low-side threshold voltage; and
a fault trigger circuit configured to provide the interruption to the digital processing circuit in a presence of any of the high-side fault indication and the low-side fault indication.

9. The motor drive system of claim 7, wherein the digital processing circuit is further configured to determine the high-side threshold voltage and the low-side threshold voltage based on a lookup table that correlates the high-side threshold voltage and the low-side threshold voltage with a root-mean-square of the digitized feedback of the three phase currents and the three gate drive voltages.

10. A method for monitoring state-of-health of a motor drive system comprising:
powering a three-phase motor with three phase voltages to thereby induce three phase currents;
biasing a three-phase inverter coupled between a positive voltage rail and a negative voltage rail by three gate drive voltages to thereby provide the three phase voltages to the three-phase motor;
receiving feedback of the three phase currents and feedback of the three phase voltages;
determining a state-of-health of the three-phase motor based on the feedback of the three phase currents;
determining a state-of-health of the three-phase inverter based on the feedback of the three phase currents and the feedback of the three phase voltages; and
determining an overall state-of-health of the motor drive system based on the determined state-of-health of the three-phase motor and the determined state-of-health of the three-phase inverter.

11. The method of claim 10, further comprising:
digitizing the feedback of the three phase currents and the feedback of the three phase voltages;
determining the state-of-health of the three-phase motor based on the digitized feedback of the three phase currents; and
determining the state-of-health of the three-phase inverter based on the digitized feedback of the three phase currents and the digitized feedback of the three phase voltages.

12. The method of claim 11, further comprising:
determining a fundamental frequency of the three-phase motor;
performing one or more iterations of Discrete Fourier Transform (DFT) and harmonic damping filtering on the digitized feedback of the three phase currents to thereby calculate a first left harmonic, a second left harmonic, a first right harmonic, and a second right harmonic relative to the determined fundamental frequency;
calculating a motor vibration index based on the first left harmonic calculated through the one or more iterations; and
calculating a motor demagnetizing index based on the second left harmonic, the first right harmonic, and the second right harmonic calculated through the one or more iterations.

13. The method of claim 11, further comprising:
calculating a balance index of the digitized feedback of the three phase currents; and
applying notch filtering on the balance index to thereby determine a motor phase imbalance index.

14. The method of claim 11, further comprising:
determining a fault condition in the three-phase inverter based on a high-side threshold voltage and a low-side threshold voltage;
generating an interruption in response to detecting the fault condition; and
disabling a gate driver that biases the three-phase inverter and the three gate drive voltages to thereby protect the three-phase inverter.

15. The method of claim 14, further comprising:
generating a high-side fault indication when a voltage drop between the positive voltage rail and each of the three phase voltages is higher than the high-side threshold voltage;
generating a low-side fault indication when a voltage drop between each of the three phase voltages and the negative voltage rail is higher than the low-side threshold voltage; and
generating the interruption in a presence of any of the high-side fault indication and the low-side fault indication.

16. The method of claim 14, further comprising determining the high-side threshold voltage and the low-side threshold voltage based on a lookup table that correlates the high-side threshold voltage and the low-side threshold voltage with a root-mean-square of the digitized feedback of the three phase currents and the three gate drive voltages.

17. An electric equipment comprising a motor drive system, the motor drive system comprises:
a three-phase motor powered by three phase voltages to thereby induce three phase currents;
a three-phase inverter coupled between a positive voltage rail and a negative voltage rail, the three-phase inverter is biased by three gate drive voltages to thereby provide the three phase voltages to the three-phase motor; and
a motor control circuit configured to:
generate the three gate drive voltages to thereby bias the three-phase inverter;
receive feedback of the three phase currents and feedback of the three phase voltages;
determine a state-of-health of the three-phase motor based on the feedback of the three phase currents;
determine a state-of-health of the three-phase inverter based on the feedback of the three phase currents and the feedback of the three phase voltages; and
determine an overall state-of-health of the motor drive system based on the determined state-of-health of the three-phase motor and the determined state-of-health of the three-phase inverter.

18. The electric equipment of claim 17, wherein the motor control circuit comprises a digital processing circuit configured to:
digitize the feedback of the three phase currents and the feedback of the three phase voltages;
determine the state-of-health of the three-phase motor based on the digitized feedback of the three phase currents; and
determine the state-of-health of the three-phase inverter based on the digitized feedback of the three phase currents and the digitized feedback of the three phase voltages.

19. The electric equipment of claim 18, wherein the digital processing circuit is further configured to:
determine a fundamental frequency of the three-phase motor;
perform one or more iterations of Discrete Fourier Transform (DFT) and harmonic damping filtering on the digitized feedback of the three phase currents to thereby calculate a first left harmonic, a second left harmonic, a first right harmonic, and a second right harmonic relative to the determined fundamental frequency;
calculate a motor vibration index based on the first left harmonic calculated through the one or more iterations; and
calculate a motor demagnetizing index based on the second left harmonic, the first right harmonic, and the second right harmonic calculated through the one or more iterations.

20. The electric equipment of claim 18, wherein the digital processing circuit is further configured to:
calculate a balance index of the digitized feedback of the three phase currents; and
apply notch filtering on the balance index to thereby determine a motor phase imbalance index.
